(19) United States
(12) Patent Application Publication
(10) Pub. No.: US 2006/0290414 A1
(43) Pub. Date: Dec. 28, 2006

(54) Charge pump circuit and semiconductor memory device having the same

(75) Inventors: Jung-Sik Kim, Suwon-si (KR); Hyung-Dong Kim, Suwon-si (KR)

Correspondence Address: F. CHAU & ASSOCIATES, LLC, 130 WOODBURY ROAD, WOODBURY, NY, 11797, US

(73) Assignee: Samsung Electronics Co., LTD., Suwon-si (KR)

(21) Appl. No.: 11/435,336

(22) Filed: May 16, 2006

(30) Foreign Application Priority Data
Jun. 24, 2005 (KR) 2005-0055277

(51) Int. Cl. G05F 1/10

(52) U.S. Cl. 327/536

(57) ABSTRACT

A charge pump circuit includes a switch for transmitting an electric charge between a pumping node and an output of the charge pump circuit such that a pre-charge voltage level is applied to a control node during pre-charge operation and a pumping control voltage level is applied to the control node during pumping operation, and a control circuit for changing a level of the control node in response to a control signal to turn off the switch.

### CROSS-REFERENCE TO RELATED APPLICATION

This application claims the benefit of Korean Patent Application No. 2005-55277, filed Jun. 24, 2005 in the Korean Intellectual Property Office, the disclosure of which is hereby incorporated herein by reference in its entirety.

### BACKGROUND OF THE INVENTION

1. Field of the Invention

The present invention relates to a charge pump circuit and, more particularly, to a charge pump circuit and a semiconductor memory device having the same in which electric current consumption is reduced during a power down mode.

2. Description of Related Art

A typical charge pump circuit repetitively performs pre-charge operations and pumping operations to pump a pumping node and transmit an electric charge of the pumping node to an output of the charge pump via a charge transmission transistor to thereby generate a high voltage.

A semiconductor memory device includes the high voltage generating circuit to generate a high voltage, which is applied to a word line driver. A word line driver drives a word line with the high voltage.

The semiconductor memory device operates in a power down mode to reduce consumption of an external power voltage applied from an external portion. However, the high voltage generating circuit of the semiconductor memory device, and more particularly the charge transmission transistor, stays turned on to continuously transmit an electric current from the pumping node to the output of the charge pump even though it does not need to generate the high voltage during the power down mode.

Thus, the semiconductor memory device having the high voltage generating circuit is not suitable for a portable device that needs low power consumption.

FIG. 1 is a block diagram illustrating a high voltage generating circuit. The high voltage generating circuit of FIG. 1 includes a control signal generating circuit 10, pre-charge circuits 12 and 14, capacitors C1 and C2, level shifters 16 and 18, and NMOS transistors N1 and N2.

The control signal generating circuit 10 generates a pre-charge control signal P1 having an opposite phase to an active command ACT and generates first and second pumping control signals P2 and P3, which have opposite phase to each other when the active command ACT having a high level is applied. The pre-charge circuits 12 and 14 respectively pump nodes A and B by a pre-charge voltage level, for example, an external power voltage VEXT level, in response to the pre-charge control signal P1. The capacitors C1 and C2 respectively pump nodes A and B by the external power voltage VEXT level in response to the first and second pumping control signals P2 and P3. The level shifters 16 and 18 respectively control nodes C and D to have the pre-charge voltage level, for example, the external power voltage VEXT level, during the pre-charge operation, and respectively change the levels of the nodes C and D to, for example, a voltage “VEXT+VPP” level in response to first and second pumping control signals P2 and P3 during the pumping operation. The NMOS transistors N1 and N2 are turned on in response to the levels of the nodes C and D, respectively, to transmit the electric charge of the node A to the node B and the electric charge of the node B to the high voltage VPP generating terminal.

FIG. 2 is a timing diagram illustrating operation of the high voltage generating circuit of FIG. 1. During a pre-charge time period T1, when the active command ACT having a low level is applied, the pre-charge control signal P1 having a high level is generated from the control signal generating circuit 10. When the pre-charge control signal P1 having a high level is generated, the pre-charge circuits 12 and 14 pre-charge the nodes A and B to the external power voltage VEXT level, respectively. The level shifters 16 and 18 pre-charge the nodes C and D to the external power voltage VEXT level in response to the pre-charge control signal P1.

During a first pumping time period T2, when the active command ACT having a high level is applied, the first pumping control signal P2 having a high level is generated from the control signal generating circuit 10. When the first pumping control signal P2 having a high level is generated, a voltage of the node A is pumped to a voltage 2VEXT level by the capacitor C1. The level shifter 16 changes a level of the node C to a voltage “VEXT+VPP” level from the external voltage VEXT level in response to the first pumping control signal P2. The NMOS transistor N1 is turned on in response to the voltage “VEXT+VPP” level. As a result, charge sharing is performed between the nodes A and B, and the nodes A and B have a voltage 1.5VEXT, respectively.

During a second pumping time period T3, the first pumping control signal P2 having a low level and the second pumping control signal P3 having a high level are generated from the control signal generating circuit 10. When the second pumping control signal P3 having a high level is generated, the node B is pumped to a voltage 2.5VEXT level by the capacitor C2. The level shifter 18 changes the node D to a voltage “VEXT+VPP” level from the external power voltage VEXT in response to the second pumping control signal P3. The NMOS transistor N2 is turned on in response to the voltage “VEXT+VPP” level. As a result, charge sharing is performed between the node B and the high voltage VPP generating terminal, so that the high voltage VPP level is pumped.

The high voltage generating circuit of FIG. 1 generates the same control signals P1, P2 and P3 as the pre-charge time period T1 if a power down command PD is activated. As a result, the node B becomes the external power voltage VEXT level, and the node D also becomes the external power voltage VEXT level. Thus, the NMOS transistor N2 is not turned off but turned on continuously, whereby the electric current continuously flows to the high voltage VPP generating terminal from the node B.

Accordingly, it is difficult to reduce the electric current consumed in the high voltage generating circuit even through the power down command PD is generated.

### SUMMARY OF THE INVENTION

According to an exemplary embodiment of the present invention a charge pump circuit includes a switch for transmitting an electric charge between a pumping node and an output of the charge pump circuit such that a pre-charge voltage level is applied to a control node during pre-charge operation and a pumping control voltage level is applied to the control node during pumping operation, and a control circuit for changing a level of the control node in response to a control signal to turn off the switch.

The switch is a first NMOS transistor. The control circuit includes a second NMOS transistor which is turned on in response to the control signal to make the control node become a ground voltage level. The switch is a first PMOS transistor. The control circuit includes a second PMOS transistor which is turned on in response to the control signal to make the control node become a power voltage level.

According to an exemplary embodiment of the present invention a charge pump circuit includes a first charge transmission transistor for transmitting an electric charge between a pumping node and an output of the charge pump circuit in response to a level of a control node, a pre-charge circuit for pre-charging the pumping node and the control node to a pre-charge voltage level during pre-charge operation, and for pumping the pumping node and changing a level of the control node to a pumping control voltage level during pumping operation, and a control circuit for controlling a level of the control node in response to a control signal to turn off the first charge transmission transistor.

The first charge transmission transistor is a first NMOS transistor. The control circuit includes a second NMOS transistor which is turned on in response to the control signal to make the control node become a ground voltage level. The first charge transmission transistor is a first PMOS transistor. The control circuit includes a second PMOS transistor which is turned on in response to the control signal to make the control node become a power voltage level. The pre-charge circuit includes a pre-charge circuit for pre-charging the pumping node and at least one additional node to the pre-charge voltage level during the pre-charge operation, a first pumping circuit for pumping the at least one additional node in response to a first pumping control signal during the pumping operation, a second charge transmission transistor for transmitting the electric charge to the pumping node from the at least one additional node during the pumping operation, a first level shifter for applying the pre-charge voltage level to a gate of the second charge transmission transistor during the pre-charge operation and applying a pumping control voltage level to a gate of the second charge transmission transistor during the pumping operation, in response to the first pumping control signal, a second pumping circuit for pumping the pumping node in response to a second pumping control signal during the pumping operation, and a second level shifter for applying the pre-charge voltage level to a gate of the first charge transmission transistor during the pre-charge operation and applying the pumping control voltage level to a gate of the first charge transmission transistor during the pumping operation, in response to the second pumping control signal.

According to an exemplary embodiment of the present invention a semiconductor memory device includes a command decoder for generating an active command and a power down command in response to a command signal applied from an external portion, and a charge pump circuit including a switch for transmitting an electric charge between a pumping node and an output of the charge pump circuit such that a pre-charge voltage level is applied to a control node during pre-charge operation and a pumping control voltage level is applied to the control node during pumping operation, and a control circuit for changing a level of the control node in response to a control signal to turn off the switch.

### BRIEF DESCRIPTION OF THE DRAWINGS

The present invention will become more apparent to those of ordinary skill in the art by describing in detail, preferred embodiments thereof with reference to the attached drawings in which:

FIG. 1 is a block diagram illustrating a charge pump circuit;

FIG. 2 is a timing diagram illustrating operation of the charge pump circuit of FIG. 1;

FIG. 3 is a block diagram illustrating a charge pump circuit according to an exemplary embodiment of the present invention;

FIG. 4 is a timing diagram illustrating operation of the charge pump circuit of FIG. 3; and

FIG. 5 is a block diagram illustrating a semiconductor memory device having the charge pump circuit according to an exemplary embodiment of the present invention.

### DETAILED DESCRIPTION OF PREFERRED EMBODIMENTS

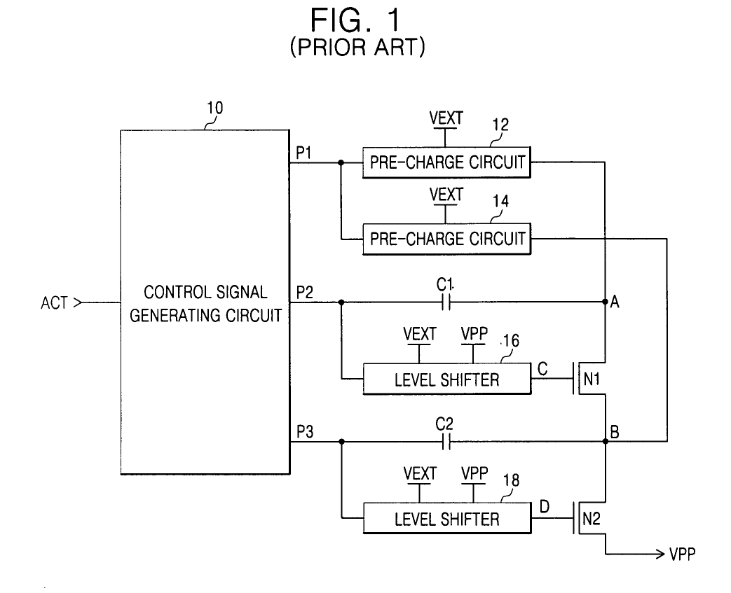

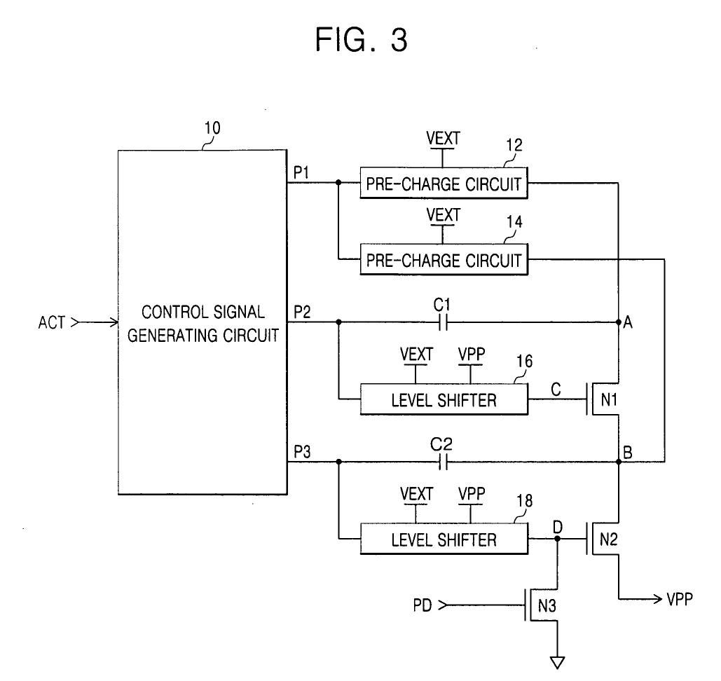

FIG. 3 is a block diagram illustrating a charge pump circuit according to an exemplary embodiment of the present invention. The charge pump circuit of FIG. 3 includes an NMOS transistor N3 in addition to a configuration of the charge pump circuit of FIG. 1.

Like reference numerals of FIGS. 1 and 3 denote like parts and perform like functions, and thus functions of like parts will not be described.

The NMOS transistor N3 is turned on to control the node D to have a ground voltage level when the power down command PD having a high level is generated. As a result, the NMOS transistor N2 is turned off, so that the electric current does not flow to the high voltage VPP generating terminal from the node B.

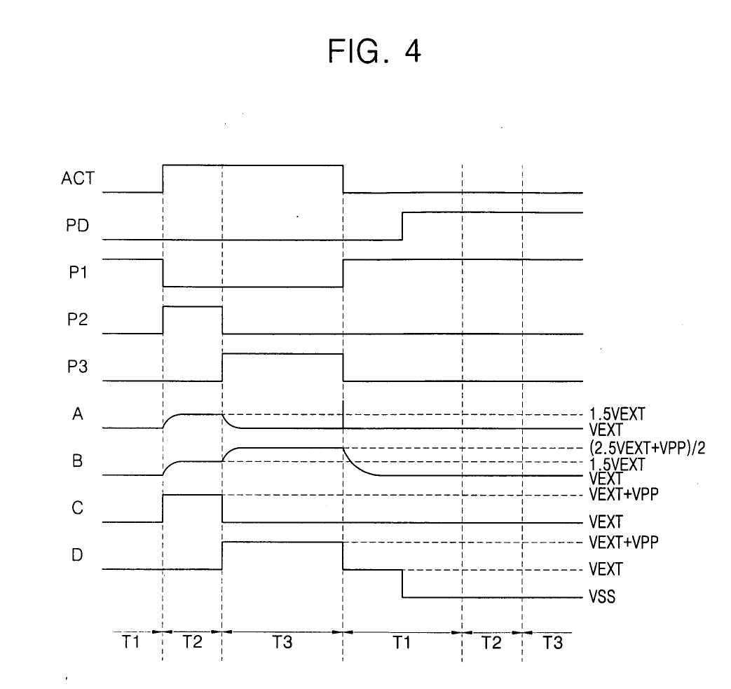

FIG. 4 is a timing diagram illustrating operation of the charge pump circuit of FIG. 3.

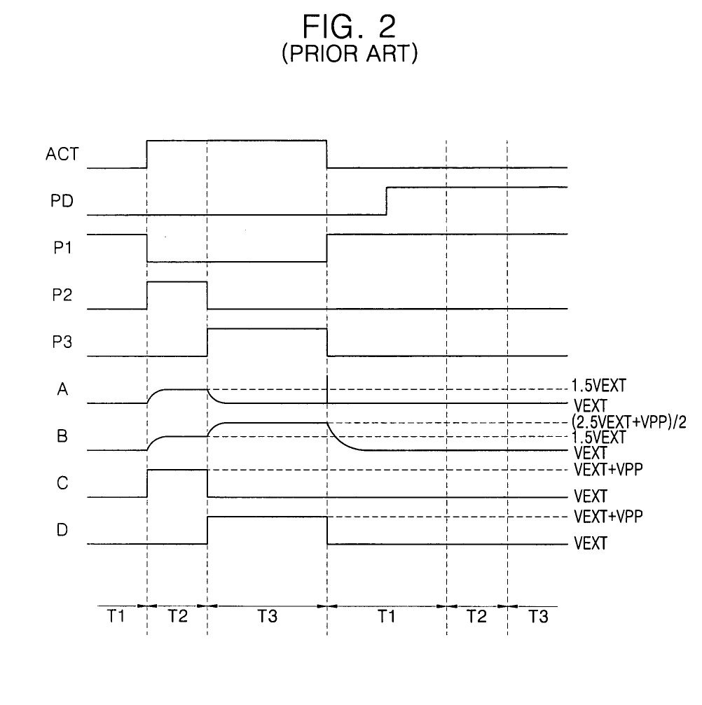

Operation of a charge pump circuit according to an embodiment of the present invention in the pre-charge time period T1, the first pumping time period T2 and the second pumping time period T2 is similar to those of FIG. 2.

When the power down command PD is generated during the pre-charge time period T1 after the second pumping time period T3, the control signals P1, P2 and P3 are generated substantially identically to the pre-charge time period T1. The nodes A, B and C become the external power voltage VEXT level identically to the pre-charge time period T1. The NMOS transistor T3 is turned on in response to the power down signal PD having a high level to control the node D to have the ground voltage VSS level. Thus, the NMOS transistor N3 is turned off, so that the electric current does not flow to the high voltage VPP generating terminal from the node B.

According to an embodiment of the present invention, the charge pump circuit of the present invention can substantially prevent the electric current from flowing through the NMOS transistor N3 when the NMOS transistor N3 is turned off in response to the power down command PD. Thus, the high voltage VPP generating terminal is not supplied with the electric current and so drops to the ground voltage VSS level.

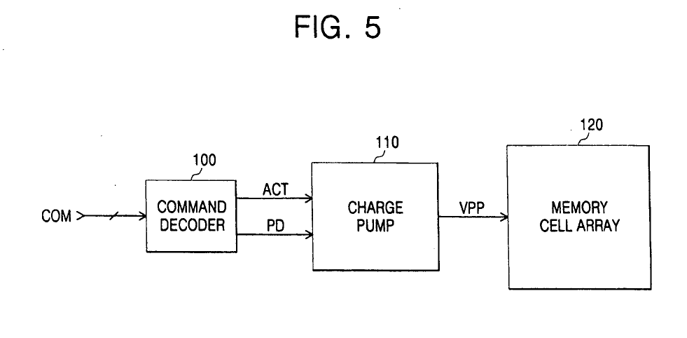

FIG. 5 is a block diagram illustrating a semiconductor memory device having the charge pump circuit according to an embodiment of the present invention. The semiconductor memory device of FIG. 5 includes a command decoder 100, a charge pump circuit 110, and a memory cell array. The command decoder 100 decodes a command signal COM applied from an external portion to generate an active command ACT and a power down command PD. The charge pump circuit 100 performs the pumping operation in response to the active command ACT to generate the high voltage VPR The charge pump circuit 100 removes the electric current which flows to a high voltage VPP generating terminal (e.g., an output of the charge pump circuit) in response to the power down command PD, removing the electric current which flows to the high voltage VPP generating terminal from the node B. The memory cell array 120 receives the high voltage VPP to drive the word line (not shown) by the word line driver (not shown).

In FIG. 5, a command signal corresponding the power down command PD is inputted to the command decoder 100 and the power down command PD is generated by the command decoder 100. The power down command PD can be applied directly to the charge pump circuit 110 from an external portion.

The charge pump circuit of the semiconductor memory device according to an embodiment of the present invention removes the electric current which flows through the NMOS transistor N2 of FIG. 3, e.g., the charge transmission transistor, in response to the power down command PD, whereby consumption of the external power voltage VEXT does not occur.

In embodiments described herein, the charge pump circuit is described as performing a two-step pumping operation. The charge pump circuit may perform a pumping operation having a different number of steps, e.g., a three- or four-step pumping operation.

In a device including the pumping node and the charge transmission transistor, the pumping node and a gate of the charge transmission transistor are pre-charged to the pre-charge voltage so that the charge transmission transistor is turned on during the power down mode.

In embodiments described herein, a gate of the NMOS transistor becomes the ground voltage VSS level when the power down command PD is activated in case where the charge transmission transistor is comprised of the NMOS transistor. A gate of the PMOS transistor may become the external power voltage VEXT level when the power down command PD is activated in a case where the charge transmission transistor is comprised of the PMOS transistor.

In embodiments described herein, the external power voltage VEXT level is used as the pre-charge voltage level. A voltage obtained by subtracting a threshold voltage of the NMOS transistor from the external power voltage VEXT can be used as the pre-charge voltage level.

In embodiments described herein, the external power voltage VEXT is used as a power voltage. An internal power voltage generated by using the external power voltage VEXT can be used as a power voltage.

The high voltage generating circuit according to an embodiment of the present invention can reduce power consumption by removing the electric current which flows to the output of the charge pump circuit from the pumping node.

The semiconductor memory device having the high voltage generating circuit according to an embodiment of the present invention can reduce consumption of the electric current consumed in the charge pump circuit during the power down mode.

Thus, if the semiconductor memory device according to an embodiment of the present invention is implemented, consumption of the external power can be reduced.

What is claimed is:

1. A charge pump circuit, comprising:
a switch for transmitting an electric charge between a pumping node and an output of the charge pump circuit such that a pre-charge voltage level is applied to a control node during pre-charge operation and a pumping control voltage level is applied to the control node during pumping operation; and
a control circuit for changing a level of the control node in response to a control signal to turn off the switch.

2. The circuit of claim 1, wherein the switch is a first NMOS transistor.

3. The circuit of claim 2, wherein the control circuit includes a second NMOS transistor which is turned on in response to the control signal to make the control node become a ground voltage level.

4. The circuit of claim 1, wherein the switch is a first PMOS transistor.

5. The circuit of claim 4, wherein the control circuit includes a second PMOS transistor which is turned on in response to the control signal to make the control node become a power voltage level.

6. A charge pump circuit, comprising:
a first charge transmission transistor for transmitting an electric charge between a pumping node and an output of the charge pump circuit in response to a level of a control node;
a pre-charge circuit for pre-charging the pumping node and the control node to a pre-charge voltage level during pre-charge operation, and for pumping the pumping node and changing a level of the control node to a pumping control voltage level during pumping operation; and
a control circuit for controlling a level of the control node in response to a control signal to turn off the first charge transmission transistor.

7. The circuit of claim 6, wherein the first charge transmission transistor is a first NMOS transistor.

8. The circuit of claim 7, wherein the control circuit includes a second NMOS transistor which is turned on in response to the control signal to make the control node become a ground voltage level.

9. The circuit of claim 6, wherein the first charge transmission transistor is a first PMOS transistor.

10. The circuit of claim 9, wherein the control circuit includes a second PMOS transistor which is turned on in response to the control signal to make the control node become a power voltage level.

11. The circuit of claim 6, wherein the pre-charge circuit comprises:
a pre-charge circuit for pre-charging the pumping node and at least one additional node to the pre-charge voltage level during the pre-charge operation;
a first pumping circuit for pumping the at least one additional node in response to a first pumping control signal during the pumping operation;
a second charge transmission transistor for transmitting the electric charge to the pumping node from the at least one additional node during the pumping operation;
a first level shifter for applying the pre-charge voltage level to a gate of the second charge transmission transistor during the pre-charge operation and applying a pumping control voltage level to a gate of the second charge transmission transistor during the pumping operation, in response to the first pumping control signal;
a second pumping circuit for pumping the pumping node in response to a second pumping control signal during the pumping operation; and
a second level shifter for applying the pre-charge voltage level to a gate of the first charge transmission transistor during the pre-charge operation and applying the pumping control voltage level to a gate of the first charge transmission transistor during the pumping operation, in response to the second pumping control signal.

12. A semiconductor memory device, comprising:
a command decoder for generating an active command and a power down command in response to a command signal applied from an external portion; and
a charge pump circuit including a switch for transmitting an electric charge between a pumping node and an output of the charge pump circuit such that a pre-charge voltage level is applied to a control node during pre-charge operation and a pumping control voltage level is applied to the control node during pumping operation, and a control circuit for changing a level of the control node in response to a control signal to turn off the switch.

13. The device of claim 12, wherein the switch is a first NMOS transistor.

14. The device of claim 13, wherein the control circuit includes a second NMOS transistor which is turned on in response to the control signal to make the control node become a ground voltage level.

15. The device of claim 12, wherein the circuit is a first PMOS transistor.

16. The device of claim 15, wherein the control circuit includes a second PMOS transistor which is turned on in response to the control signal to make the control node become a power voltage level.

17. The device of claim 12, wherein the charge pump circuit further includes a pre-charge circuit for pre-charging the pumping node and the control node to a pre-charge voltage level during the pre-charge operation, and for pumping the pumping node and changing a level of the control node to a pumping control voltage level during the pumping operation.
